(19) United States
(12) Patent Application Publication
(10) Pub. No.: US 2010/0198902 A1
(43) Pub. Date: Aug. 5, 2010

(54) COMPUTING MINIMAL POLYNOMIALS OF RADICAL EXPRESSIONS

(75) Inventors: Xu Yang, Beijing (CN); Zhouchen Lin, Beijing (CN); Sijun Liu, Beijing (CN); Tianjun Ye, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/364,533

(22) Filed: Feb. 3, 2009

(51) Int. Cl. G06F 7/552

(52) U.S. Cl. 708/605

(57) ABSTRACT

Described is a technology, such as implemented in a computational software program, by which a minimal polynomial is efficiently determined for a radical expression based upon its structure of the radical expression. An annihilation polynomial is found based upon levels of the radical to obtain roots of the radical. A numerical method performs a zero test or multiple zero tests to find the minimal polynomial. In one implementation, the set of roots corresponding to a radical expression is found. The annihilation polynomial is computed by grouping roots of the set according to their conjugation relationship and multiplying factor polynomials level by level. A selection mechanism selects the minimal polynomial based upon the annihilation polynomial's factors.

### BACKGROUND

Minimal polynomials are widely used in symbolic computation. Computing the minimal polynomial of a radical expression (or more simply “radical” as used herein) is a basic problem in symbolic computation. Some examples include factorization of polynomials in an algebraic extension field, rationalization of denominators, and simplification of complex expressions.

The existing algorithms are all limited to radicals over the ring Z of integer numbers or the field Q of rational numbers.

Determining the minimal polynomial of radicals over a ring is a well known question for problems related to algebraic extension. One conventional method finds an annihilation polynomial, factors the polynomial, and then finds the minimal polynomial from the factors. However, for many types of radicals, computational software programs that use known methods cannot find the results and/or fail, and are computationally expensive (that is, relatively slow) particularly for complex radicals.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a minimal polynomial is efficiently determined for a radical expression based upon the structure of the radical expression. To this end, an annihilation polynomial is found based upon levels of the radical (level substitution) to obtain roots of the radical. The roots are used to compute an annihilation polynomial (via hierarchical cancellation). A numerical method performs a zero test or multiple zero tests to find the minimal polynomial.

In one aspect, a set of roots corresponding to a radical expression is found. The annihilation polynomial is computed by grouping roots of the set according to their conjugation relationship and multiplying factor polynomials level by level. A selection mechanism selects the minimal polynomial based upon the factors corresponding to the annihilation polynomial.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for computing minimal polynomials of radical expressions.

FIG. 2 is a flow diagram showing example steps taken to compute the minimal polynomial of a radical expression that is a ring radical.

FIG. 3 is a flow diagram showing example steps taken to compute the minimal polynomial of a radical expression that is a division of two ring radicals.

FIG. 4 shows an illustrative example of a computing environment into which various aspects of the present invention may be incorporated.

### DETAILED DESCRIPTION

Various aspects of the technology described herein are generally directed towards finding an annihilation polynomial for radicals over a ring using a level permutation group method, along with a numerical method to compute a polynomial and test the roots of polynomials by symbolic computation. When used in a computational software program, these methods find results for many types of radicals that known computational software programs cannot find or fail to find, and are computationally much faster than known computational software programs, including for complex radicals.

In one aspect, this technology provides an efficient hierarchical elimination mechanism (algorithm) for computing the annihilation polynomials of radical expressions over a general ring or field. One such algorithm also works for radical expressions with variables, such as expressions over Z[x, y . . . z] or Q[x, y . . . z]. By factoring the annihilation polynomials, the minimal polynomials can be obtained.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing in general.

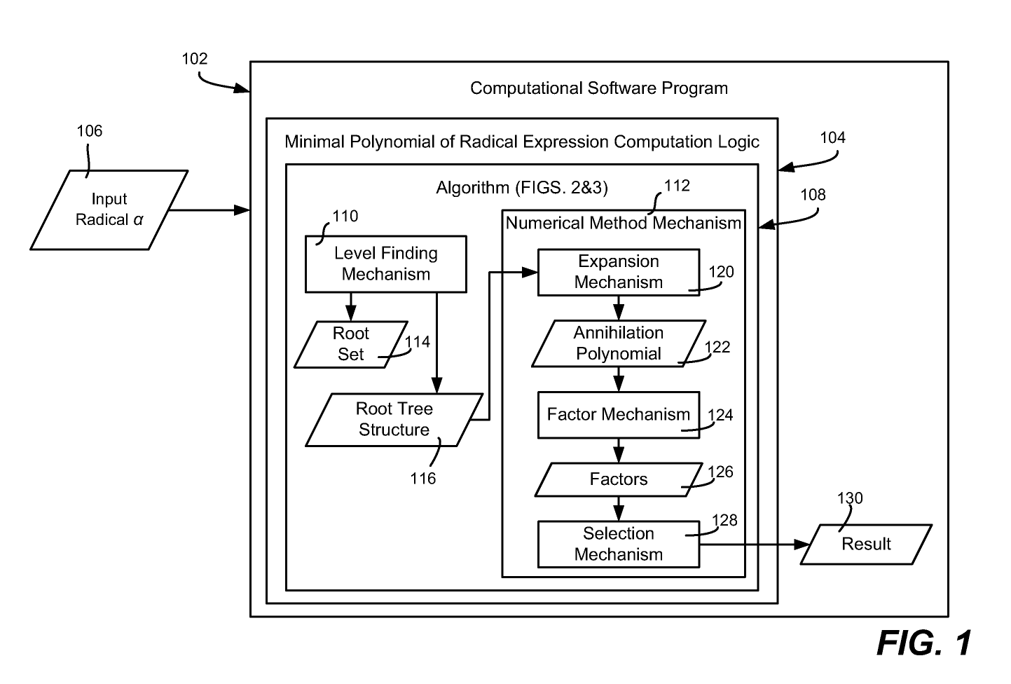

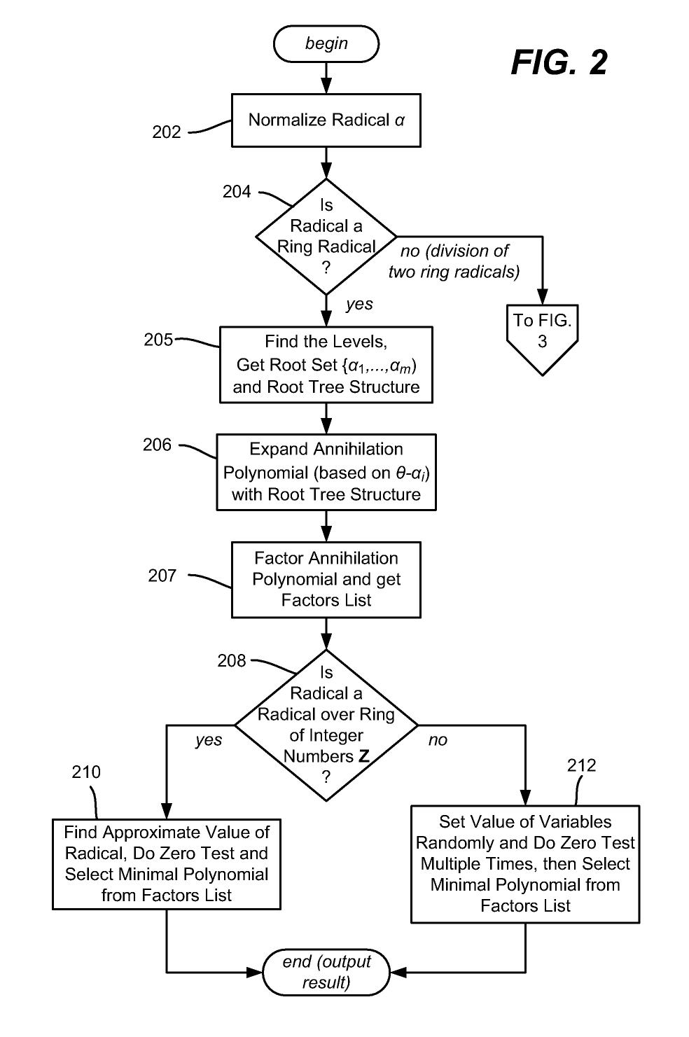

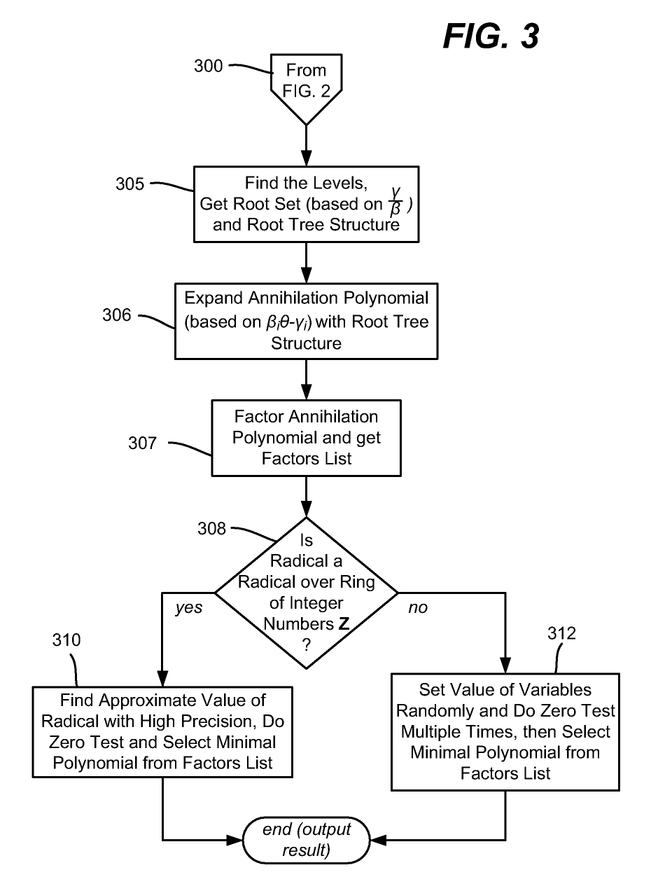

FIG. 1 shows various aspects related to finding an annihilation polynomial by using a level permutation group based on the structure of radicals. In the example implementation of FIG. 1, a computational software program 102 includes logic 104 for computing a minimal polynomial of a given radical expression, or radical 106. To this end, the logic 104 includes an algorithm 108 (described below with reference to FIGS. 2 and 3), including a level finding mechanism 110 that finds the levels of the radical 106, and a numerical method mechanism 112.

In general, the level finding mechanism computes a root set 114 and root tree structure 116. Further, as will be understood, for radicals over Q or Z, a known (classical) method is modified through the numerical method mechanism 112. To this end, the root tree structure 116 is expanded via an expansion mechanism 120 into a computed annihilation polynomial 122, which is then factored by a factor mechanism 124 (e.g., using known algorithms) into a set of factors 126. A selection mechanism selects the minimal polynomial from the factors.

Turning to the various mechanisms and computed data, radicals over a ring (field) X are defined via the following recursion:
1. x is a radical, ∀xεX;
2. if R₁ and R₂ are radicals, so are
   ^{m}\sqrt{R₁}, R₀=R₁+R₂, R₀=R₁−R₂, R₀=R₁×R₂ and R₀=R₁/R₂, where m is a positive integer.

If a radical R is generated by the above rules (except using R₀=R₁/R₂), then it is called a ring radical. Radicals over Z and Q form a major class of algebraic numbers.

As used herein, a “level” is a concept related to the structure of a radical. Intuitively, the level of a component of a radical is the number of nested radical signs over it. More particularly, given a radical R, the levels of its components are defined via the following recursion:

1. the level of R itself is defined as 0;
2. if R₀ is decomposed in either of the following ways:

R₀=R₁+R₂, R₀=R₁−R₂, R₀=R₁×R₂ or R₀=R₁/R₂

where R₁ and R₂ are radicals, then the levels of R₁ and R₂ are the same as R₀.
3. if R₀=^{m}\sqrt{R₁}, then the level of R₁ is that of R₀ plus 1.

Radicals are defined herein to be nested radicals or the results of nested radicals after arithmetic operations. If the ring to which the items in these nested radical belong is known, the radicals are said to be radicals over the ring. For example,

$$\frac{\sqrt{5 + \sqrt{2}}}{\sqrt[3]{3 + 2 \sqrt{2}}} - \sqrt[3]{\frac{3}{4}} \times \sqrt{6}$$

are radicals over Q and

$$\sqrt[3]{\sqrt{\frac{2 y}{5}} + \sqrt[5]{3 x}}$$

are radicals over Q[x, y].

To get an image of radicals, the items under i radical are considered to be at the (i+1)^{th}-level. Taking

$$\frac{7 \sqrt{5 + \sqrt{2}}}{\sqrt[3]{3 + 2 \sqrt{2 + \sqrt{3 + \sqrt{5}}}}} - \sqrt[3]{\frac{3}{4}} \times \sqrt{6}$$

as an example, the first level (with no higher radical) are items from the above example are:

$$7 , \sqrt{5 + \sqrt{2}} , \sqrt[3]{3 + 2 \sqrt{2 + \sqrt{3 + \sqrt{5}}}} , \sqrt[3]{\frac{3}{4}} , \sqrt{6} .$$

The second level comprises items under one radical, which are

$$5 , \sqrt{2} , 3 , 2 , \sqrt{2 + \sqrt{3 + \sqrt{5}}} , \frac{3}{4} , 6.$$

These can also be obtained by collecting the first level of items in the first level. As can be seen, the third level comprises 2, 2, \sqrt{3+\sqrt{5}}, the fourth level comprises 3, \sqrt{5} and the fifth level is 5.

These primitive items have certain level properties, including that a first level property is that the (i+1)^{th} level can be obtained by collecting the first levels of items in the i^{th} level. A second level property is that every item in the i^{th} level either belongs to the ring, or is a rational power of results after arithmetic operations of items in the (i+1)^{th} level. By the first property the levels of a radical are found by the level finding mechanism 110. The second property is used to find the annihilation polynomial as described below.

To find a root set 114, the level finding mechanism 110 aims to find the roots of the annihilation polynomial 122 of a given radical a (input radical 106), such that the polynomial is in X[θ]. The root set 114 is obtained recursively as described hereinafter. A general idea is to find conjugate roots at every level, so that the immediate radical signs over that level can be removed.

Consider that the highest level in α is n. Starting from the (n−1)-th level, the root set is initialized to be Aₙ={α}. For each element α_{q}⁽ⁱ⁺¹⁾ in Aᵢ₊₁, consider its different primitive items at level i that do not belong to X. By the second property above, they can be written as:

$$\sqrt[{m}_{p}]{{β}_{p}} , p = 1 , … , {k}_{i} .$$

Then α_{q}ⁱ⁺¹ generates πₚ₌₁^{k}^{ᵢ} mₚ roots in the next level root set Aᵢ, by replacing its i-th level primitive items

$$\sqrt[{m}_{p}]{{β}_{p}} with \sqrt[{m}_{p}]{{β}_{p}} {ɛ}_{{m}_{p}}^{{r}_{p}} , {r}_{p} = 0 , 1 , … , {m}_{p} - 1 , p = 1 , … , {k}_{i} ,$$

where

$${ɛ}_{m} = {e}^{\frac{2 π j}{m}} and j = \sqrt{- 1} .$$

Deleting the duplicated elements in the set of newly generated roots obtains Aᵢ. The above recursion stops when i=0, and A₀ is the set of complete roots.

The roots in Aᵢ, which are generated from the same element of Aᵢ₊₁ by the above replacement, are referred to as the depth-i conjugate roots. Then the root set may be represented in the tree structure 116 by the depth and the conjugation:

$$α \to \{ \begin{matrix}{α}_{1} \to \{ \begin{matrix}\begin{matrix}{α}_{11} \to \{ \begin{matrix}… \\ … \\ …\end{matrix} \\ …\end{matrix} \\ {α}_{1 k} \to \{ \begin{matrix}… \\ … \\ …\end{matrix}\end{matrix} \\ {α}_{m} \to \{ \begin{matrix}{α}_{m 1} \to \{ \begin{matrix}… \\ … \\ …\end{matrix} \\ … \\ {α}_{m l} \to \{ \begin{matrix}… \\ … \\ …\end{matrix}\end{matrix}\end{matrix}$$

where the elements at depth i of the above tree are the roots in Aₙ₋ᵢ (assuming that α is at depth 0).

By way of example, consider a radical over ringZ[x]:

$$\sqrt{1 - \sqrt{5}} + \sqrt[3]{x - \sqrt{5}} ;$$

its highest level is 2. Thus, the initial root set is A₂={r}. The different 1-st level primitive items of a that do not belong to Z[x] are: \sqrt{5}. Thus, the depth-1 root set is:

$${A}_{1} = \{ \begin{matrix}\sqrt{1 - \sqrt{5}} + \sqrt[3]{x - \sqrt{5}} , \\ \sqrt{1 - \sqrt{5}} + \sqrt[3]{x + \sqrt{5}}\end{matrix} \} ≡ \{ {α}_{1} , {α}_{2} \}$$

where α₁ and α₂ are depth-1 conjugate roots as they are both generated from a.

Next, for α₁ the different 0-th level primitive items that do not belong to Z[x] are:

$$\sqrt{1 - \sqrt{5}} and \sqrt[3]{x - \sqrt{5}} .$$

Thus, α₁ generates the following depth-2 conjugate roots in A₀:

$$\{ \begin{matrix}\sqrt{1 - \sqrt{5}} + \sqrt[3]{x - \sqrt{5}} , \sqrt{1 - \sqrt{5}} + \sqrt[3]{x - \sqrt{5}} {ɛ}_{3} , \\ \sqrt{1 - \sqrt{5}} + \sqrt[3]{x - \sqrt{5}} {ɛ}_{3}^{2} , - \sqrt{1 - \sqrt{5}} + \sqrt[3]{x - \sqrt{5}} , - \\ \sqrt{1 - \sqrt{5}} + \sqrt[3]{x - \sqrt{5}} {ɛ}_{3} , - \sqrt{1 - \sqrt{5}} + \sqrt[3]{x - \sqrt{5}} {ɛ}_{3}^{2}\end{matrix} \} .$$

Similarly, the conjugate roots in A₀ generated by α₂ can also be found. Thus:

$${A}_{0} = \{ \begin{matrix}\sqrt{1 - \sqrt{5}} + \sqrt[3]{x - \sqrt{5}} , \sqrt{1 - \sqrt{5}} + \sqrt[3]{x - \sqrt{5}} {ɛ}_{3} , \\ \sqrt{1 - \sqrt{5}} + \sqrt[3]{x - \sqrt{5}} {ɛ}_{3}^{2} , - \sqrt{1 - \sqrt{5}} + \sqrt[3]{x - \sqrt{5}} , - \\ \sqrt{1 - \sqrt{5}} + \sqrt[3]{x - \sqrt{5}} {ɛ}_{3} , - \sqrt{1 - \sqrt{5}} + \sqrt[3]{x - \sqrt{5}} {ɛ}_{3}^{2} , \\ \sqrt{1 + \sqrt{5}} + \sqrt[3]{x + \sqrt{5}} , \sqrt{1 + \sqrt{5}} + \sqrt[3]{x + \sqrt{5}} {ɛ}_{3} , \\ \sqrt{1 + \sqrt{5}} + \sqrt[3]{x + \sqrt{5}} {ɛ}_{3}^{2} , - \sqrt{1 + \sqrt{5}} + \sqrt[3]{x + \sqrt{5}} , - \\ \sqrt{1 + \sqrt{5}} + \sqrt[3]{x + \sqrt{5}} {ɛ}_{3} , - \sqrt{1 + \sqrt{5}} + \sqrt[3]{x + \sqrt{5}} {ɛ}_{3}^{2}\end{matrix} \}$$

A radical is either a ring radical, or can be written as the division of two ring radicals. Thus, only two forms of radicals need be considered, as set forth below:

Theorem: Given the root set A₀
1. If the radical α is a ring radical, then f(θ)=π_{α}_{_{q}}_{εA}_{₀}(θ−α_{q}) is the annihilation polynomial of α in X[θ];
2. If

$$α = \frac{γ}{β} ,$$

where both γ and β are ring radicals, then the root set can be expressed as

$${A}_{0} = \{ \frac{{γ}_{q}}{{β}_{q}} \vert {γ}_{q} and {β}_{q}$$

are both ring radicals, q=1, . . . , K} and the annihilation polynomial in X[θ] is f(θ)=π_{q=1}^{K}(β_{q}θ−γ_{q}).

Turning to expanding the annihilation polynomial, as described above, the roots in A₀ can be grouped according to their conjugate relationship. Consider that there are N groups A_{0,k}, k=1, . . . , N. Then the annihilation polynomial f(θ)=πₖ₌₁^{N}fₖ(θ), where fₖ(θ)=π_{α}_{_{q}}_{εA}_{_{0,k}}(θ−α_{q}). As the radical signs of the 0-th level primitive items are removed when fₖ(θ) is expanded (because it is a symmetric polynomial of these conjugate roots), when multiplying among the 0-th level primitive items, the process only needs to check whether the radical signs of the chosen primitive items can be removed after multiplying them. This checking operation is very fast; for every primitive item of the form

$$\sqrt[m]{β} ,$$

it appears p·m times in the chosen primitive items, where p is a nonnegative integer. If this criterion is not satisfied, the multiplication is not performed. Otherwise, the multiplication result is added to an accumulation buffer for fₖ(θ).

After expanding all fₖ(θ), k=1, . . . , N, they are further grouped according to the conjugate relationship at the depth (n−1) of the tree. Then the above testing is also performed when expanding the product of fₖ(θ) in each group, whereby the 1-st level radical signs will removed. This procedure goes on until depth 1 of the tree. Then the completely expanded annihilation polynomial f(θ) is obtained.

By way of an example, consider the radical \sqrt{1−\sqrt{5}}+

$$\sqrt{1 - \sqrt{5}} + \sqrt[3]{x - \sqrt{5}} .$$

The tree structure of the root sets is as follows:

$$\sqrt{1 - \sqrt{5}} + \sqrt[3]{x - \sqrt{5}} \to \{ \begin{matrix}\sqrt{1 - \sqrt{5}} + \sqrt[3]{x - \sqrt{5}} \to \{ \begin{matrix}\sqrt{1 - \sqrt{5}} + \sqrt[3]{x - \sqrt{5}} \\ \sqrt{1 - \sqrt{5}} + \sqrt[3]{x - \sqrt{5}} {ɛ}_{3} \\ \sqrt{1 - \sqrt{5}} + \sqrt[3]{x - \sqrt{5}} {ɛ}_{3}^{2} - \\ \sqrt{1 - \sqrt{5}} + \sqrt[3]{x - \sqrt{5}} - \\ \sqrt{1 - \sqrt{5}} + \sqrt[3]{x - \sqrt{5}} {ɛ}_{3} - \\ \sqrt{1 - \sqrt{5}} + \sqrt[3]{x + \sqrt{5}} {ɛ}_{3}^{2}\end{matrix} \\ \sqrt{1 + \sqrt{5}} + \sqrt[3]{x + \sqrt{5}} \to \{ \begin{matrix}\sqrt{1 + \sqrt{5}} + \sqrt[3]{x + \sqrt{5}} \\ \sqrt{1 + \sqrt{5}} + \sqrt[3]{x + \sqrt{5}} {ɛ}_{3} \\ \sqrt{1 + \sqrt{5}} + \sqrt[3]{x + \sqrt{5}} {ɛ}_{3}^{2} - \\ \sqrt{1 + \sqrt{5}} + \sqrt[3]{x + \sqrt{5}} - \\ \sqrt{1 + \sqrt{5}} + \sqrt[3]{x + \sqrt{5}} {ɛ}_{3} - \\ \sqrt{1 + \sqrt{5}} + \sqrt[3]{x + \sqrt{5}} {ɛ}_{3}^{2}\end{matrix}\end{matrix}$$

When computing f₁(θ) using the first group of depth-2 roots, multiplications such as:

$$\sqrt{1 - \sqrt{5}} \sqrt{1 - \sqrt{5}} \sqrt[3]{x - \sqrt{5}} {ɛ}_{3}^{2} \sqrt[3]{x - \sqrt{5}} \sqrt[3]{x - \sqrt{5}} {ɛ}_{3} θ$$

are performed and also stored because the level-0 radical signs are removed. In this way,

$${f}_{1} ( θ ) = {θ}^{6} + 3 ( \sqrt{5} - 1 ) {θ}^{4} + ( 2 \sqrt{5} - 2 x ) {θ}^{3} - 6 ( - 3 + \sqrt{5} ) {θ}^{2} + ( 6 ( - 5 + \sqrt{5} ) + 6 ( - 1 + \sqrt{5} ) x ) y + {x}^{2} - 2 \sqrt{5} x + 8 \sqrt{5} - 11.$$

$$Similarly , \\ {f}_{2} ( θ ) = {θ}^{6} - 3 ( \sqrt{5} + 1 ) {θ}^{4} + ( - 2 \sqrt{5} - 2 x ) {θ}^{3} + 6 ( 3 + \sqrt{5} ) {θ}^{2} + ( - 6 ( 5 + \sqrt{5} ) - 6 ( 1 + \sqrt{5} ) x ) θ + {x}^{2} - 2 \sqrt{5} x - 8 \sqrt{5} - 11.$$

$$Therefore , \\ f ( θ ) = {f}_{1} ( θ ) {f}_{2} ( θ ) = - 199 + 160 x - 42 {x}^{2} + {x}^{4} + ( 180 - 228 x + 60 {x}^{2} - 12 {x}^{3} ) θ + ( 804 - 120 x - 180 {x}^{2} ) {θ}^{2} + ( - 880 + 228 x - 4 {x}^{3} ) {θ}^{3} + ( - 150 + 60 x + 18 {x}^{2} ) {θ}^{4} + ( 120 - 216 x ) {θ}^{5} + ( 30 + 6 {x}^{2} ) {θ}^{6} - 120 {θ}^{7} - 4 \times {θ}^{9} - 6 {θ}^{10} + {θ}^{12} .$$

With respect to computing the minimal polynomial, after obtaining the annihilation polynomial, the annihilation polynomial can be factored using known algorithms to select the minimal polynomial by substituting the radical and performing a zero test. However, it is usually very difficult to do such a zero test by symbolic computation, and thus numerical methods are employed as described herein. For a radical over Z or Q, the numerical value of the radical is computed and then checked as to whether it fulfills a factored polynomial at a high precision. For a radical over Z[x, y, . . . , z] or Q[x, y, . . . , z], the values of x, y, . . . , z may be randomly selected multiple times, and then the numerical zero test performed.

FIGS. 2 and 3, representing the algorithm below, summarize the logic 104:

For a radical α over the ring Z, Q, Z[x], Z[x, y, . . . z],Q[x], or Q[x, y, . . . z],

Normalize α to make it a radical over Z, Z[x] or Z[x, y, . . . z] (step 202).
If (α is a ring radical) (step 204, else if not, to step 300 of FIG. 3)

{
Find the levels, get the root set {α₁, . . . , αₘ} and root tree structure (step
205).
Expand f(θ) = Πᵢ₌₁^{m} (θ − αᵢ) with root tree structure (step 206).
Factor f(θ) and get factors list {P₁(θ), . . . , Pₖ(θ)} (step 207).

If (α is radical over Z) (step 208)
{
find approximate value of α, do zero test and select minimal

polynomial from factors list (step 210).

}
Else
{
set the value of variables randomly and do zero test multiple times,

then select minimal polynomial from factors list (step 212).

}

}

else if (α is division of two ring radicals,
$α = \frac{γ}{β} )$ (step 300 of FIG. 3).

{
Find the levels, get the roots set
$\{ \frac{{γ}_{1}}{{β}_{1}} , … , \frac{{γ}_{m}}{{β}_{m}} \}$ and roots tree structure (step 305).
Expand f(θ) = Πᵢ₌₁^{m}(βᵢθ − γᵢ) with root tree structure (step 306).
Factor f(θ) and get factors list {P₁(θ), . . . , Pₖ(θ)}(step 307).

If (α is radicals over Z) (step 308)
{
find approximate value of α with high precision, do zero test and select

minimal polynomial from factors list (step 310).

}
Else
{
set the value of variables randomly and do zero test multiple times,

then select minimal polynomial from factors list (step 312).

}

}

Step 214 or 314 represent outputting the resulting minimal polynomial, e.g., to another component of the computer software program for further processing or outputting to the user.

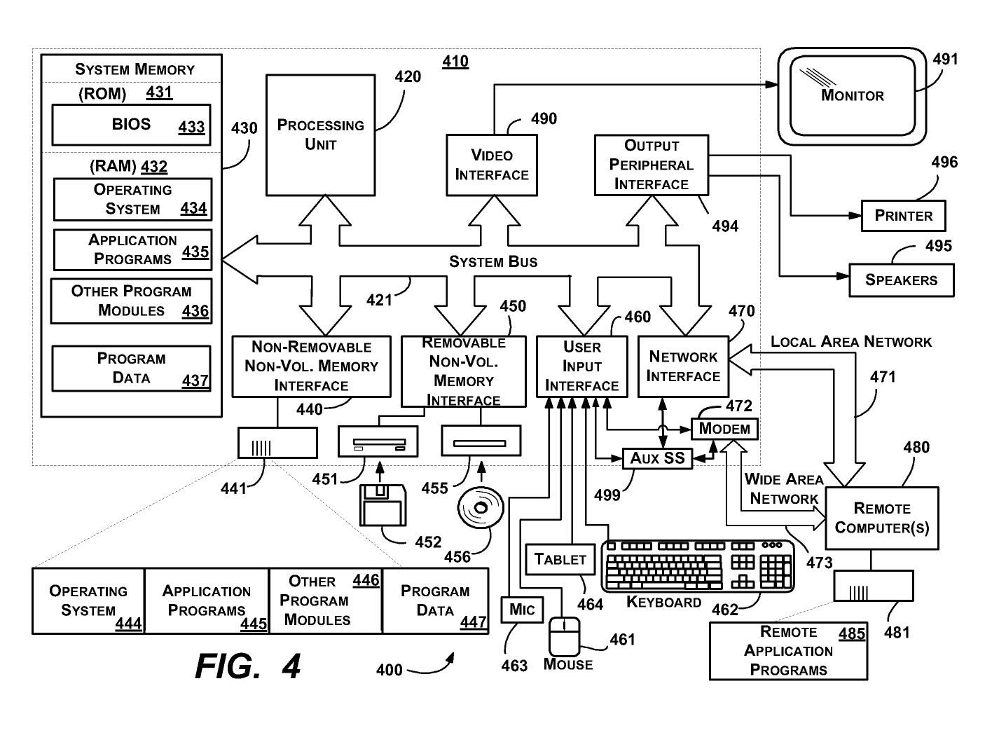

Exemplary Operating Environment FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, determining levels of a radical expression, using the levels to find roots of an annihilation polynomial, factoring the annihilation polynomial into factors, and selecting a minimal polynomial based upon the factors.

2. The method of claim 1 wherein determining the levels of the radical expression comprises recursively processing levels into a root set for each level.

3. The method of claim 2 wherein a plurality of root sets are provided, and further comprising constructing a root structure corresponding to the root sets.

4. The method of claim 3 wherein using the levels to find roots of an annihilation polynomial comprises performing an expansion based upon the roots into expanded results, and grouping the expanded results into the annihilation polynomial based upon the root structure.

5. The method of claim 4 wherein performing the expansion comprises determining whether the radical expression corresponds to a ring radical or a division of two ring radicals.

6. The method of claim 1 further comprising determining whether the radical expression is a radical over a ring of integer numbers.

7. The method of claim 1 further comprising outputting the minimal polynomial as a result.

8. In a computing environment, a system comprising, a level finding mechanism that finds a set of roots corresponding to a radical expression, an expansion mechanism that computes an annihilation polynomial by grouping roots of the set according to their conjugation relationship and multiplying factor polynomials level by level, and a selection mechanism that selects a minimal polynomial based upon factors corresponding to the annihilation polynomial.

9. The system of claim 8 wherein the expand mechanism processes a root tree structure into the annihilation polynomial.

10. The system of claim 8 wherein the level finding mechanism, the expand mechanism and the selection mechanism are incorporated into a computational software program.

11. One or more computer-readable media having computer-executable instructions, which when executed perform steps, comprising, performing level substitution to obtain roots of a radical expression, and performing hierarchical cancellation based upon the roots to compute an annihilation polynomial corresponding to the radical expression.

12. The one or more computer-readable media of claim 11 having further computer-executable instructions comprising selecting a minimal polynomial based on factors computed from the annihilation polynomial.

13. The one or more computer-readable media of claim 11 having further computer-executable instructions comprising normalizing the radical expression.

14. The one or more computer-readable media of claim 11 having further computer-executable instructions comprising determining whether the radical expression is a ring radical, and if so, wherein performing hierarchical cancellation includes expanding root-based annihilation polynomials into the annihilation polynomial.

15. The one or more computer-readable media of claim 14 having further computer-executable instructions comprising, determining whether the radical expression is a ring over integers, and if so, selecting a minimal polynomial from a set of factors by finding an approximate value corresponding to the radical expression and performing a zero test.

16. The one or more computer-readable media of claim 14 having further computer-executable instructions comprising determining whether the radical expression is a ring over integers, and if not, selecting a minimal polynomial from a set of factors by randomly setting variable values and performing a plurality of zero tests.

17. The one or more computer-readable media of claim 11 having further computer-executable instructions comprising determining whether the radical expression is a division of two ring radicals, and if so, wherein performing hierarchical cancellation includes expanding divided root-based annihilation polynomials into the annihilation polynomial.

18. The one or more computer-readable media of claim 17 having further computer-executable instructions comprising determining whether the radical expression is a ring over integers, and if so, selecting a minimal polynomial from a set of factors by finding an approximate value corresponding to the radical expression and performing a zero test.

19. The one or more computer-readable media of claim 17 having further computer-executable instructions comprising determining whether the radical expression is a ring over integers, and if not, selecting a minimal polynomial from a set of factors by randomly setting variable values and performing a plurality of zero tests.

20. The one or more computer-readable media of claim 11 having further computer-executable instructions comprising outputting results corresponding to a minimal polynomial.
